(19) United States
(12) Patent Application Publication
(10) Pub. No.: US 2003/0050165 A1
(43) Pub. Date: Mar. 13, 2003

(54) Box gluing machine

(76) Inventor: Hui-nan Hung, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/948,652

(22) Filed: Sep. 10, 2001

(51) Int. Cl. B31B 1/62

(52) U.S. Cl. 493/150

(57) ABSTRACT

A box gluing machine includes a paperboard providing device, a folding device, a heat-air blowing device, a side adhering device, an adjustment device, a compression device, a transportation device and a lateral transportation device. The heat-air blowing device includes a right board, a mediate board and a left board, wherein the right board and the left board respectively have heating members and adjustment members. The mediate board has a transportation portion. The heating members each include a blower, a pipe connected to the blower, and a body having a nozzle. The adjustment members each have a back-and-forth adjustment member, an angular adjustment member and an up-and-down adjustment member.

### FIELD OF THE INVENTION

The present invention relates to a box gluing machine that automatically glues paperboard boxes and is operated safely.

### BACKGROUND OF THE INVENTION

A conventional box gluing machine is shown in FIG. 1 and includes several heating devices for heating and melting the glue on the surfaces of paperboards so that the paperboards can be adhered with each other by the melted glue. The heating devices use gas to provide flames and the temperature is not easily to control so that the paperboards are darkened or even burned if the flames are not properly used. Besides, the paperboards are easily burned at a limited temperature so that there is a potential risk to use the conventional box gluing machine. The gas is toxic but has no smell so that in a closed operation area, the users may get positioned without knowing the situation.

### SUMMARY OF THE INVENTION

In accordance with one aspect of the present invention, there is provided a box gluing machine which includes a paperboard providing device, a folding device, a heat-air blowing device, a side adhering device, an adjustment device, a compression device, a transportation device and a lateral transportation device. The heat-air blowing device includes a right board, a mediate board and a left board, wherein the right board and the left board respectively have heating members and adjustment members. The mediate board has a transportation portion. The heating members each include a blower, a pipe connected to the blower, and a body having a nozzle. The adjustment members each have a back-and-forth adjustment member, an angular adjustment member and an up-and-down adjustment member.

The primary object of the present invention is to provide a box gluing machine that uses heat-air blowing devices to melt the glue on the paperboards and the boxes can be glued in series automatically.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional box gluing machine;

FIG. 2 is an illustrative view to show the box gluing machine of the present invention;

FIG. 3 is a perspective view to show the heating devices of the box gluing machine of the present invention;

FIG. 4 is a side view to show the heating devices of the box gluing machine of the present invention;

FIGS. 5 to 7 show different operational situations of the gluing machine of the present invention.

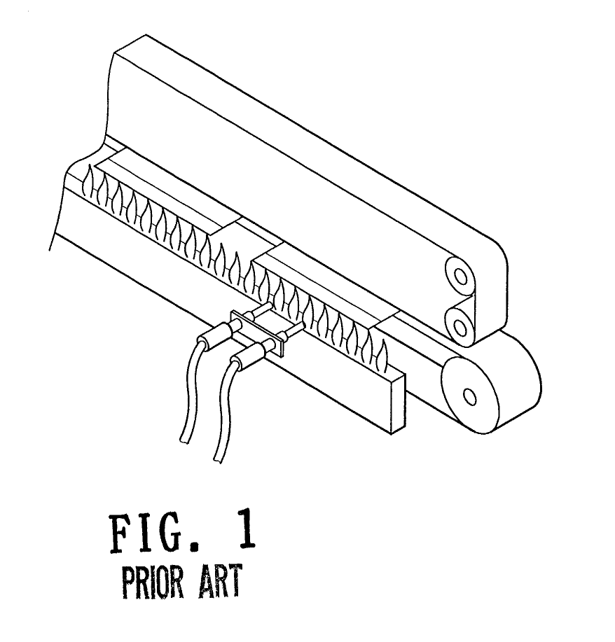

### DETAILED DESCRIPTION OF THE PREFERRED EMBODIMENT

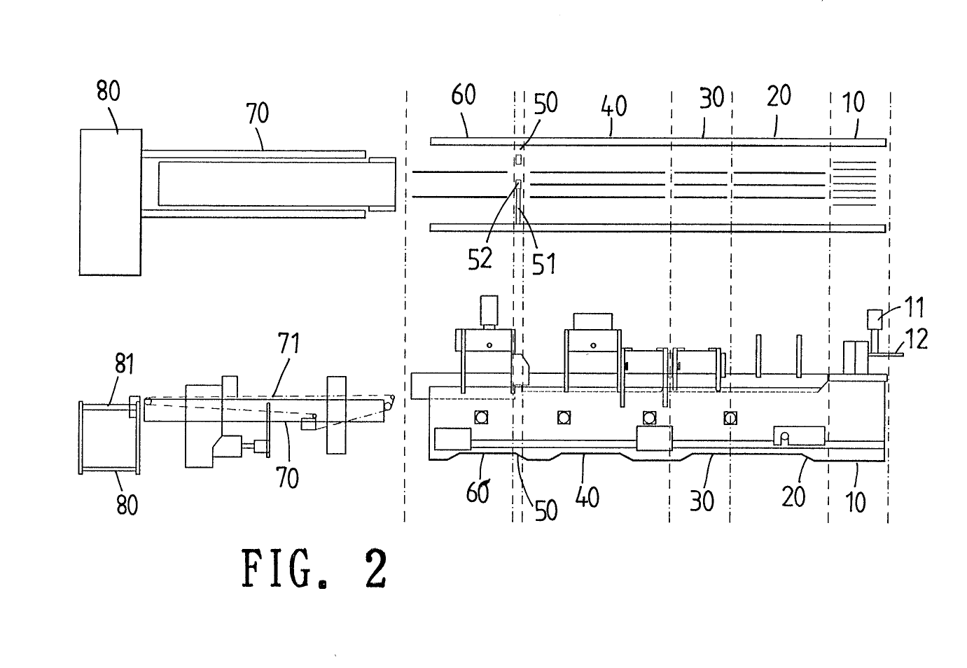

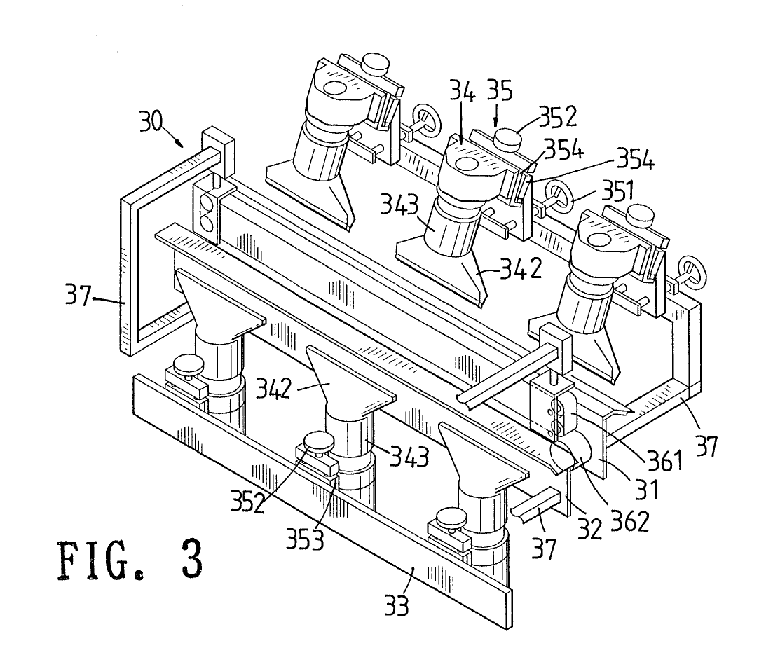

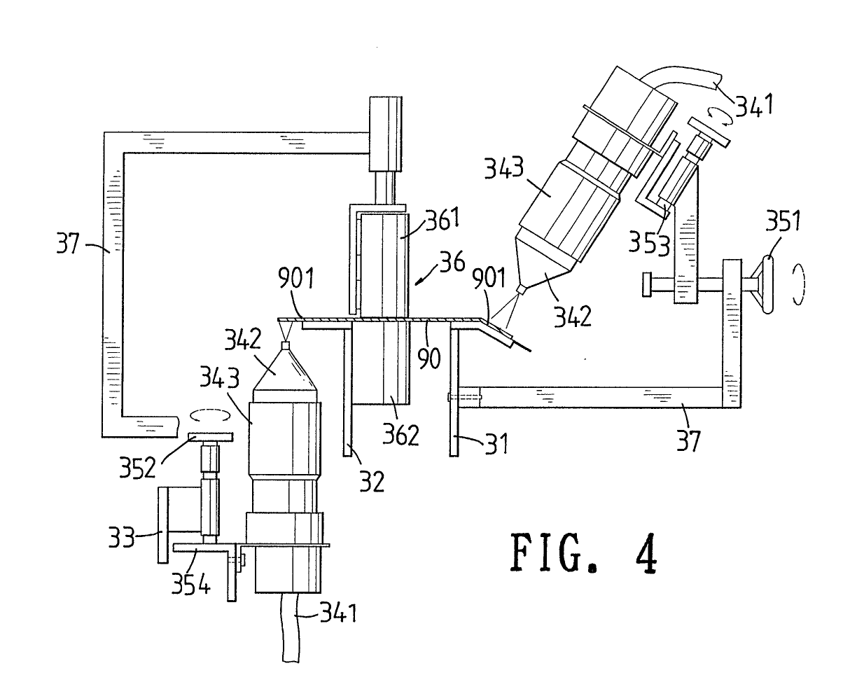

Referring to FIGS. 2 to 4, the gluing machine of the present invention comprises a paperboard providing device 10, a folding device 20, a heat-air blowing device 30, a side adhering device 40, an adjustment device 50, a compression device 60, a transportation device 70 and a lateral transportation device 80.

The paperboard providing device 10 comprises front operation box 11 and a board 12. The folding device 20 is a device to fold the paperboards. The heat-air blowing device 30 melts the glue on the paperboards. The side adhering device 40 adheres sides of two paperboards. The adjustment device 50 employs adjustment rods 51 and rollers 52 to adjust the positions of the sides of the paperboards. The compression device 60 compresses the sides of the paperboards to allow the sides of the paperboards to be well adhered. The transportation device 70 employs belt 71 to transport the paperboards that are adhered on their sides. The lateral transportation device 80 includes a box 81 and sends the paperboards which are adhered on their sides to a assembling device. The heat-air blowing device 30 involves an inventive matter so that the rest of the devices will not be described in detail.

The heat-air blowing device 30 includes a right board 31, a mediate board 32 and a left board 33. The right board 31 and the left board 33 respectively have heating members 34 and adjustment members 35. The mediate board 32 has a transportation portion 36 which is fixed by frames 37. The heating members 34 each include a blower, a pipe 341 connected to the blower, and a body 343 having a nozzle 342. The adjustment members 35 each have a back-and-forth adjustment member 351, an angular adjustment member 352 and an up-and-down adjustment member 353. The body 343 is fixed to the adjustment member 35 by using fixing a board 354 and screws. Accordingly, the paperboards that have glue on their surfaces are put on the transportation portion 36 including an upward belt 361 and a downward belt 362, and the gluing surfaces of the paperboards are melted by the heat air blown from the body 343 on the right board 31 and the left board 33.

When assembling, the parts of the heat-air blowing device 30 are positioned by the frames 237 and the screws. These parts include the transportation portion 36 on the mediate board 32, the heating members 34 and the adjustment members 35 on the right board 31 and the left board 33, and the nozzles 342 of the body 343 facing the transportation portion 36.

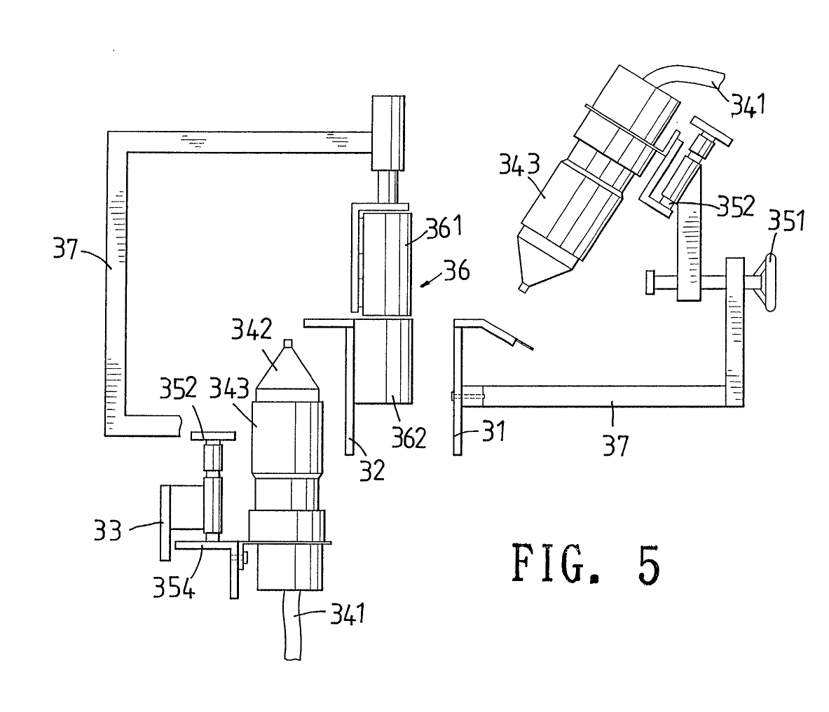

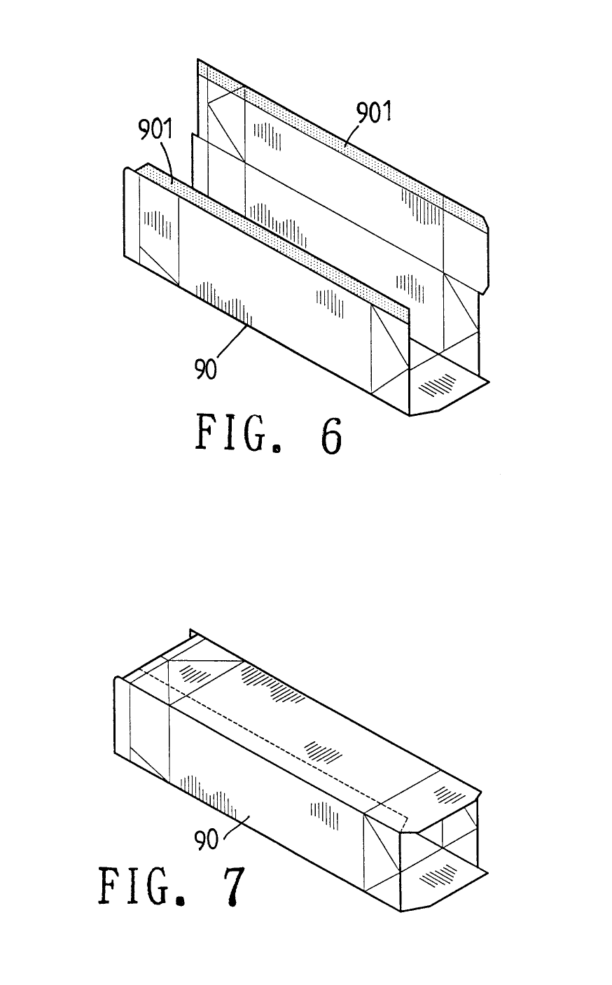

As shown in FIGS. 2-7, the transportation portion 36 of the heat-air blowing device 30 receives the paperboards 90 sent from the folding device 20. The two sides 901 of the paperboards 90 face the nozzles 342 of the body 343. The positions of the body 342 can be adjusted by the adjustment members 35. In other words, the positions of the bodies 342 are adjusted by using the back-and-forth adjustment member 351, an angular adjustment member 352 and an up-and-down adjustment member 353. Heat air is sent to the bodies 343 via the pipes 341 and heat sensors are set in the bodies 343 so as to control the temperature of the heat air in a pre-set range. When the nozzles 342 of the bodies 343 blow heat air to the sides 901 of the paperboards 90, the nozzles 341 on the right board 31 blow heat air to the top surfaces of the sides 901 of the paperboards 90 and the nozzles 342 on the left board 33 blow heat air to the bottom surfaces of the sides 901 of the paperboards 90. By this way, the glue on the sides 901 of the paperboards is melted and the two sides can be adhered with each other.

It is to be noted that the number of the heating members 34 can be multiple as practical needs and the number is three in this embodiment. The boxes to be adhered in this embodiment is milk boxes. The shape of the nozzle 342 of the body 343 of the heating members 34 can be changed according the area of the sides 901 of the paperboards 90. The sides 901 are elongated sides in the embodiment so that the nozzles are bar-shaped nozzles.

While we have shown and described the embodiment in accordance with the present invention, it should be clear to those skilled in the art that further embodiments may be made without departing from the scope of the present invention.

What is claimed is:

1. A box gluing machine comprising:
a paperboard providing device, a folding device, a heat-air blowing device, a side adhering device, an adjustment device, a compression device, a transportation device and a lateral transportation device, said heat-air blowing device comprising a right board, a mediate board and a left board, said right board and said left board respectively having heating members and adjustment members, said mediate board having a transportation portion which is fixed by frames, said heating members each including a blower, a pipe connected to the blower, and a body having a nozzle, said adjustment members each having a back-and-forth adjustment member, an angular adjustment member and an up-and-down adjustment member.
